(19) United States
(12) Patent Application Publication
(10) Pub. No.: US 2025/0240373 A1
(43) Pub. Date: Jul. 24, 2025

(54) PRINTING APPARATUS, PRINTING SYSTEM, METHOD OF CONTROLLING PRINTING APPARATUS, AND STORAGE MEDIUM

(71) Applicant: CANON KABUSHIKI KAISHA, Tokyo (JP)

(72) Inventor: TAKASHI HORIKOSHI, Tokyo (JP)

(21) Appl. No.: 19/033,909

(22) Filed: Jan. 22, 2025

(30) Foreign Application Priority Data
Jan. 23, 2024 (JP) 2024-007899

(51) Int. Cl. H04N 1/00

(52) U.S. Cl. CPC H04N 1/00676; H04N 1/00466; H04N 1/0061; H04N 1/0071

(57) ABSTRACT

A printing apparatus including a printing unit that prints an image on a print sheet by executing a print job, sheet feeders in which cut paper and roll paper each as the print sheet are selectably set for feeding to the printing unit, respectively, and a conveying unit that conveys the print sheet from the sheet feeding unit to the printing unit. In a case where a width of cut paper as a print sheet to be used in execution of the print job is larger than a width of the roll paper selected in the sheet feeder, a confirmation dialog is displayed to enable a selection operation for prompting a user to select one of execution of the print job and stoppage of execution of the print job.

### BACKGROUND OF THE INVENTION

### Field of the Invention

The present invention relates to a printing apparatus, a printing system, a method of controlling the printing apparatus, and a storage medium.

### Description of the Related Art

In recent years, when a print job is transmitted from an information processing apparatus, such as a personal computer, to a printing apparatus, a general-purpose printing protocol incorporated in an operating system (OS) of the information processing apparatus is used without using a dedicated printer driver provided from a vendor which is the manufacturer of the printing apparatus or the like. As an example of this printing protocol (standard protocol), there is known an internet printing protocol (IPP). Print processing is executed between the information processing apparatus and the printing apparatus through communication according to the IPP. Further, as a capabilities response from the printing apparatus, for example, sheet information including a variety of information, such as a sheet type, a sheet size, and a sheet feed tray, is constructed, and the sheet information is acquired via the IPP. Further, Japanese Laid-Open Patent Publication (Kokai) No. 2017-170792 describes a printing apparatus that can use roll paper as a print sheet. In the printing apparatus described in Japanese Laid-Open Patent Publication (Kokai) No. 2017-170792, in a case where the width of a sheet to be used in execution of a print job is larger than the width of the roll paper set in the printing apparatus, if the print job can be executed in this state, a printing position adjustment screen for adjusting a printing position with respect to the paper is displayed. Further, in the printing apparatus described in Japanese Laid-Open Patent Publication (Kokai) No. 2017-170792, if the print job cannot be executed in this state, execution of the print job is stopped.

Depending on the model of a printing apparatus or the type of an OS, a printing apparatus having an OS installed therein displays sheet sizes of all of cut paper supported by the printing apparatus when the print setting is performed. Even in a case where A3-sized roll paper (roll paper having a width of 297 mm), for example, is set in the printing apparatus, a user can select A2-sized cut paper which is larger in width than the A3-sized roll paper or roll paper having a width of 420 mm, on a print setting screen. Then, when printing is executed in a state in which the A2-sized cut paper is selected, there causes a problem that an image is printed in a size suitable for the A2-sized cut paper, and hence a clipped image is formed on the A3-sized roll paper due to clipping which is not intended by the user. Further, an operation of replacing the roll paper for the printing apparatus is not easier than an operation of replacing e.g. an A3-sized sheet (cut paper) with an A2-sized sheet. As described above, in the printing apparatus described in Japanese Laid-Open Patent Publication (Kokai) No. 2017-170792, in a case where the width of a sheet to be used in execution of a print job is larger than a width of roll paper set in the printing apparatus, if the print job can be executed in this state, the printing position adjustment screen can be displayed. However, even when the user operates the printing position adjustment screen, a clipped image can be formed on a printed matter.

### SUMMARY OF THE INVENTION

The present invention provides a printing apparatus, a printing system, a method of controlling the printing apparatus, and a storage medium, which are capable of preventing, when printing is performed on roll paper, formation of a clipped image on the roll paper regardless of the size of the width of the roll paper.

In a first aspect of the present invention, there is provided a printing apparatus, including at least on processor; and a memory coupled to the at least one processor storing instructions that, when executed by the processor, cause the processor to function as: a printing unit configured to print an image on a print sheet by executing a print job, a sheet feeding unit configured to have cut paper and roll paper selectably set therein each as the print sheet for feeding to the printing unit, a conveying unit configured to convey the print sheet from the sheet feeding unit to the printing unit, and a selection unit configured to enable a selection operation for prompting a user to select one of execution of the print job and stoppage of execution of the print job, in a case where, when a direction orthogonal to a direction in which the print sheet is conveyed by the conveying unit is defined as a direction of a width of the print sheet, a width of cut paper as a print sheet to be used in execution of the print job is larger than a width of the roll paper selected in the sheet feeding unit.

In a second aspect of the present invention, there is provided a printing system including a printing apparatus and an information processing apparatus communicably connected to the printing apparatus, wherein the printing apparatus includes a printing unit configured to print an image on a print sheet by executing a print job, a sheet feeding unit configured to have cut paper and roll paper selectably set therein each as the print sheet for feeding to the printing unit, and a conveying unit configured to convey the print sheet from the sheet feeding unit to the printing unit, and wherein the information processing apparatus includes a selection unit configured to enable a selection operation for prompting a user to select one of execution of the print job and stoppage of execution of the print job, in a case where, when a direction orthogonal to a direction in which the print sheet is conveyed by the conveying unit is defined as a direction of a width of the print sheet, a width of cut paper as a print sheet to be used in execution of the print job is larger than a width of the roll paper selected in the sheet feeding unit.

According to the present invention, it is possible to prevent, when printing is performed on roll paper, formation of a clipped image on the roll paper regardless of the size of the width of the roll paper.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a printing system according to a first embodiment.

FIG. 2 is a block diagram showing a hardware configuration of a computer.

FIG. 3 is a block diagram showing a hardware configuration of a printing apparatus.

FIGS. 4A-1 and 4A-2 are diagrams each showing an image to be printed and a printed result of the image to be printed.

FIG. 4B is a sequence diagram showing a process executed between a user, a print application, an OS standard print program, and the printing apparatus.

FIG. 5 is a flowchart of a process (sheet determination process) performed by the printing apparatus.

FIG. 6A is a diagram showing a first confirmation dialog displayed on the printing apparatus.

FIG. 6B is a diagram showing a second confirmation dialog displayed on the printing apparatus.

FIG. 7 is a flowchart of a process (process of the first confirmation dialog and the second confirmation dialog) performed by the printing apparatus.

FIG. 8 is a block diagram showing a hardware configuration of the printing system according to a second embodiment.

FIG. 9 is a sequence diagram showing a process executed between the user, the print application, a status monitor, the OS standard print program, and the printing apparatus.

### DESCRIPTION OF THE EMBODIMENTS

The present invention will now be described in detail below with reference to the accompanying drawings showing embodiments thereof. The configuration described in the following embodiment is given only by way of example, and is by no means intended to limit the scope of the present invention. For example, each component of the present invention can be replaced with a desired component which can exhibit the same function. Further, a desired component can be added. Further, two or more desired components (features) of the embodiments can be combined.

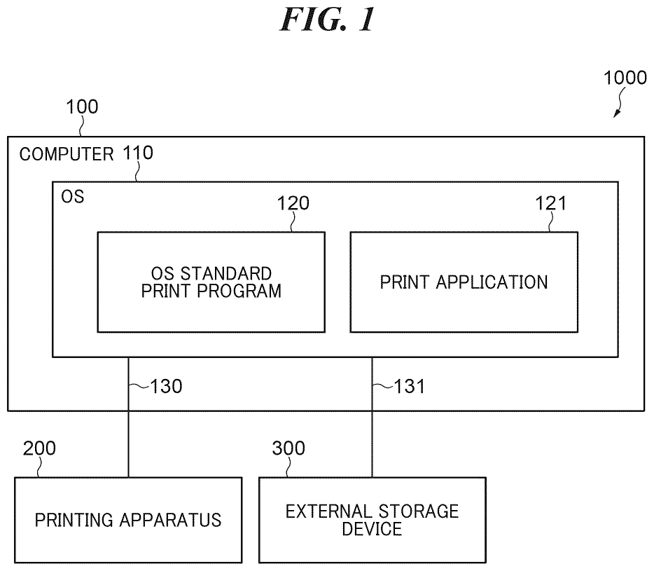

A first embodiment will be described below with reference to FIGS. 1 to 7.

FIG. 1 is a block diagram showing a hardware configuration of a printing system according to the first embodiment. As shown in FIG. 1, the printing system, denoted by reference numeral 1000, includes a computer 100, a printing apparatus 200, and an external storage device 300. The computer 100 has an OS 110 installed therein. In the OS 110, an OS standard print program 120 and a print application 121 are included. The OS standard print program 120 is software for controlling the printing apparatus 200. The OS standard print program 120 is a general-purpose print program provided by the OS 110 of the computer 100. The OS standard print program 120 is a program that generates print data which can be printed by the printing apparatuses 200 of a plurality of printer vendors (manufacturers). The print data generated by the OS standard print program 120 is transmitted to the printing apparatus 200 according to a protocol, such as the IPP. The print application 121 receives a print setting instruction from a user and instructs the printing apparatus 200 to execute printing via the OS standard print program 120. The computer 100 is not particularly limited, and, for example, an information processing apparatus, such as a desktop-type or laptop-type personal computer, a tablet terminal, or a smartphone, can be used. The printing apparatus 200 is communicably connected to the computer 100 via an interface 130. The external storage device 300 is communicably connected to the computer 100 via an interface 131. The external storage device 300 is not particularly limited, and, for example, an auxiliary storage device or a random access memory (RAM), incorporated in the computer 100, or a RAM or the like incorporated in the printing apparatus 200 can be used. Further, as the external storage device 300, an auxiliary storage device or a RAM, incorporated in a server (not shown) on a network, can be used. The server can be a server in which a maker of the printing apparatus 200 manages information concerning the printing apparatus 200. Further, each of the interface 130 and the interface 131 can be a network interface or a universal serial bus (USB) interface.

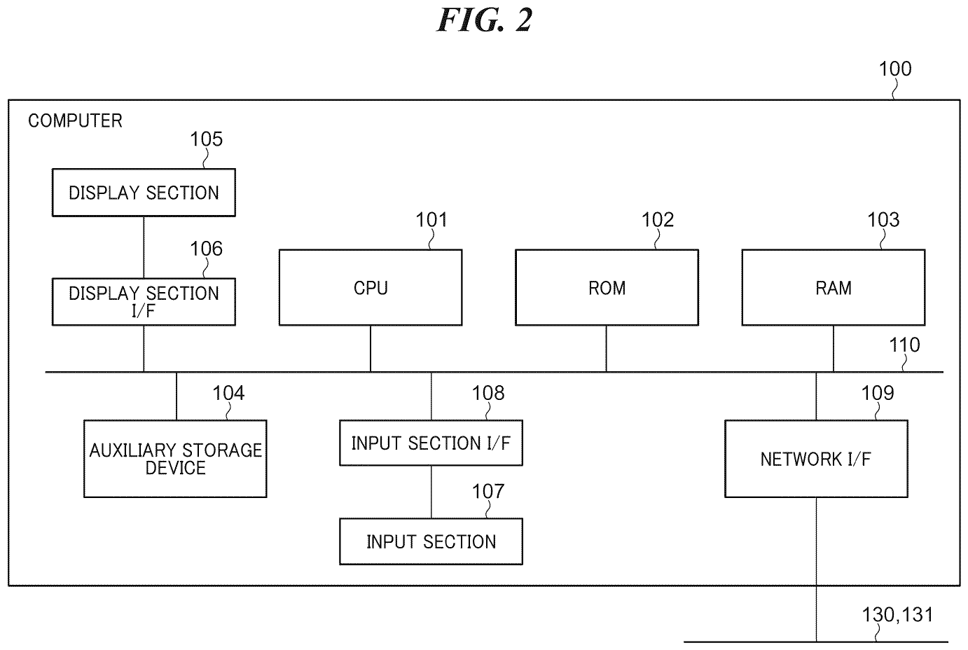

FIG. 2 is a block diagram showing a hardware configuration of the computer. As shown in FIG. 2, the computer 100 includes a central processing unit (CPU) 101, a read only memory (ROM) 102, a RAM 103, and an auxiliary storage device 104. Further, the computer 100 includes a display section 105, a display section interface (I/F) 106, an input section 107, an input section I/F 108, and a network I/F 109. Then, the components ranging from the CPU 101 to the network I/F 109 are connected via a bus 111 in a state enabled to transmit and receive data to and from each other. The CPU 101 controls the overall operation of the computer 100. This CPU 101 can execute a variety of processing operations using programs, data, and so forth, which are stored in the ROM 102 or the auxiliary storage device 104. In the ROM 102, basic software, such as basic input/output system (bios), used for controlling the computer 100, setting data which is not required to be changed, and so forth are stored. The RAM 103 is a memory having an area for storing a program and data, which is loaded from the auxiliary storage device 104 or the ROM 102, and further, a variety of programs and data, received from the outside via the network I/F 109. Further, the RAM 103 also has a work area used when the CPU 101 executes the variety of processing operations.

The auxiliary storage device 104 is a large-capacity information storage device, such as a hard disk drive device. In the auxiliary storage device 104, for example, the OS, driver software, and a variety of application software is stored. In general, the variety of application software are installed in the auxiliary storage device 104 by controlling the external storage device 300. The driver software includes, for example, display controlling driver software for controlling the display on the display section 105 via the display section I/F 106. Further, the driver software includes keyboard driver software for controlling a keyboard included in the input section 107 via the input section I/F 108. Further, the driver software includes pointing device driver software for controlling a pointing device, not shown, included in the input section 107 via the input section I/F 108. Further, the driver software includes a network driver for controlling communication via the network I/F 109. Further, the driver software includes driver software for controlling the printing apparatus 200. Further, in the present embodiment, the OS standard print program 120 has been initially installed as the software for controlling the printing apparatus 200.

On the display section 105, for example, a result of processing performed by the CPU 101 is displayed in the form of an image or characters. The display section 105 is not particularly limited, and for example, a cathode ray tube (CRT) monitor, a liquid crystal screen, or a projector (projector device) can be used. Further, as the display section 105, a touch panel screen having a display function and a user interface function can also be used. To the input section 107, a variety of information is input by an operator (user) of the computer 100, and an instruction can be provided from the input section 107 to the CPU 101 according to the input information. The input section 107 is not particularly limited, and for example, a keyboard and a pointing device can be used. The network I/F 109 is an interface that performs data communication with an external apparatus. For example, the network I/F 109 connects to an internet provider via a communication network and performs data communication with the printing apparatus 200 via the interface 130. The data communication with the printing apparatus 200 is not particularly limited, and for example, transmission of a print job to the printing apparatus 200 is performed. Note that as for connection to a communication network and the security, it is preferable to use a known method, such as the multicast domain name system (mDNS), the hyper text transfer protocol (HTTP), the IPP, and the transport layer security (TLS). The network I/F 109 is not particularly limited, and, for example, a network board can be used.

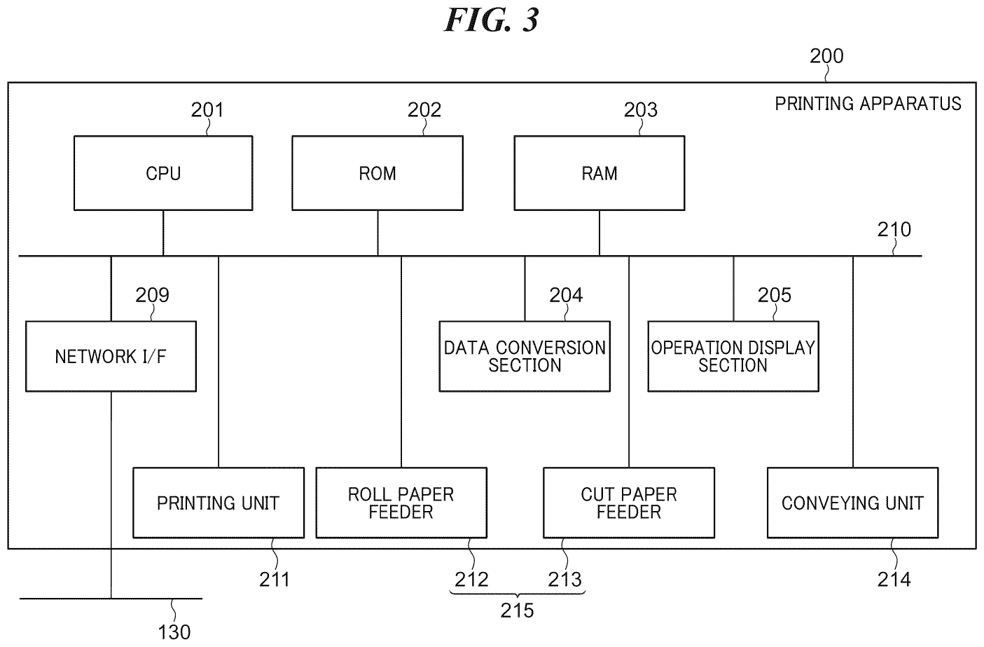

FIG. 3 is a block diagram showing a hardware configuration of the printing apparatus. The printing apparatus 200 includes a CPU 201, a ROM 202, a RAM 203, a data conversion section 204, an operation display section (display unit) 205, and a network I/F 209. Further, the printing apparatus 200 includes a printing unit 211, a roll paper feeder 212, a cut paper feeder 213, a conveying unit 214. These components included in the printing apparatus 200 are connected via a bus 210 in a state enabled to transmit and receive data to and from each other. The CPU 201 is a computer that controls the overall operation of the printing apparatus 200. In the ROM 202, a variety of programs, data, and so forth are stored. The programs include, for example, a program for causing the CPU 201 to execute a method of controlling the components and means of the printing apparatus 200 (method of controlling the printing apparatus). The RAM 203 is a memory having an area for storing a program and data loaded from the ROM 202, and further, a variety of programs and data received from the outside via the network I/F 209. Further, the RAM 203 also has a work area used when the CPU 201 executes a variety of processing operations.

The data conversion section 204 performs analysis of e.g. a page description language (PDL) and conversion of image data, such as computer graphics (CG) conversion. The PDL supported by the data conversion section 204 is e.g. PWG-Raster. On the operation display section 205, for example, a result of processing performed by the CPU 201 is displayed in the form of an image or characters. Further, the operation display section 205 displays a variety of screens, such as a menu screen, for example. The operation display section 205 is not particularly limited, and for example, a liquid crystal screen can be used, but it is preferable to use a touch panel screen having a display function and a user interface function. With this, to the operation display section 205, a variety of information is input by an operator (user) of the printing apparatus 200, and an instruction can be provided from the operation display section 205 to the CPU 201 according to the input information. The network I/F 209 is an interface that performs data communication with an external apparatus. For example, the network I/F 209 performs data communication with the computer 100 via the interface 130. The data communication with the computer 100 is not particularly limited, and for example, reception of a print job from the computer 100 is performed.

The printing unit 211 prints, by executing a print job received from the computer 100 via the network I/F 209, an image included in the print job on a print sheet. The printing method used by the printing unit 211 is not particularly limited, and, for example, a printing method using ink and a printing method using toner can be used. The print sheet is conveyed from the roll paper feeder 212 or the cut paper feeder 213 to the printing unit 211. This conveyance is performed by the conveying unit 214. The conveying unit 214 includes a plurality of rollers arranged along a direction of conveying a print sheet. The print sheet is conveyed in accordance with rotation of the rollers. In the present embodiment, a direction orthogonal to the direction in which a print sheet is conveyed by the conveying unit 214 is defined as a width direction of the print sheet.

The roll paper feeder 212, in which roll paper as a print sheet is set, supplies the set roll paper to the printing unit 211. The roll paper refers to paper which is wound into a roll in a state before printing and is used in a state opened, i.e. extended, when printing is performed. In the present embodiment, the roll paper feeder 212 can supply roll paper having a width of e.g. 10 inches to 44 inches. Further, in the roll paper feeder 212 in the present embodiment, out of a plurality of types of roll paper, which are different in width, one type of roll paper can be set, but a plurality of types of roll paper, which are different in width, cannot be collectively set. It is preferable that the roll paper feeder 212 has a roll paper detection sensor (not shown) for detecting whether or not roll paper has been set in the roll paper feeder 212 and a roll paper width sensor (not shown) for detecting a width of roll paper set in the roll paper feeder 212. The cut paper feeder 213 has print sheets set as cut paper and supplies the set cut paper to the printing unit 211. The cut paper refers to paper cut into single sheets. In the present embodiment, the cut paper feeder 213 can supply cut paper of at least one of an A-size and a B-size. Further, in the cut paper feeder 213 in the present embodiment, a plurality of types of cut paper, which are different in width, can be collectively set. It is preferable that the cut paper feeder 213 has a cut paper detection sensor (not shown) for detecting whether or not cut paper has been set in the cut paper feeder 213 and a cut paper width sensor (not shown) for detecting a width of the cut paper set in the cut paper feeder 213. Thus, in the printing apparatus 200, the roll paper feeder 212 and the cut paper feeder 213 form a sheet feeder (sheet feeding unit) 215 configured to have cut paper and roll paper selectably set therein for feeding to the printing unit 211. When printing is performed, one of the roll paper set in the roll paper feeder 212 and the cut paper set in the cut paper feeder 213 is selected. This selection is performed on an operation screen (not shown) displayed on the operation display section 205. As described above, although in the present embodiment, a plurality of types of roll paper, which are different in width, cannot be collectively set in the roll paper feeder 212, this is not limitative, but for example, the roll paper feeder 212 can be configured such that a plurality of types of roll paper, which are different in width, can be collectively set. In this case, when printing is performed, one type of roll paper is selected from the plurality of types of roll paper.

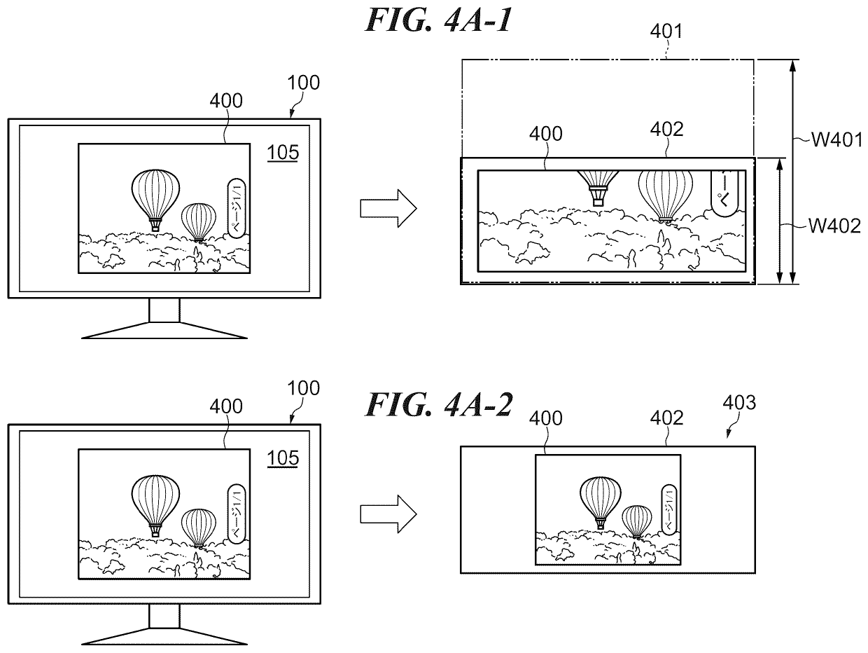

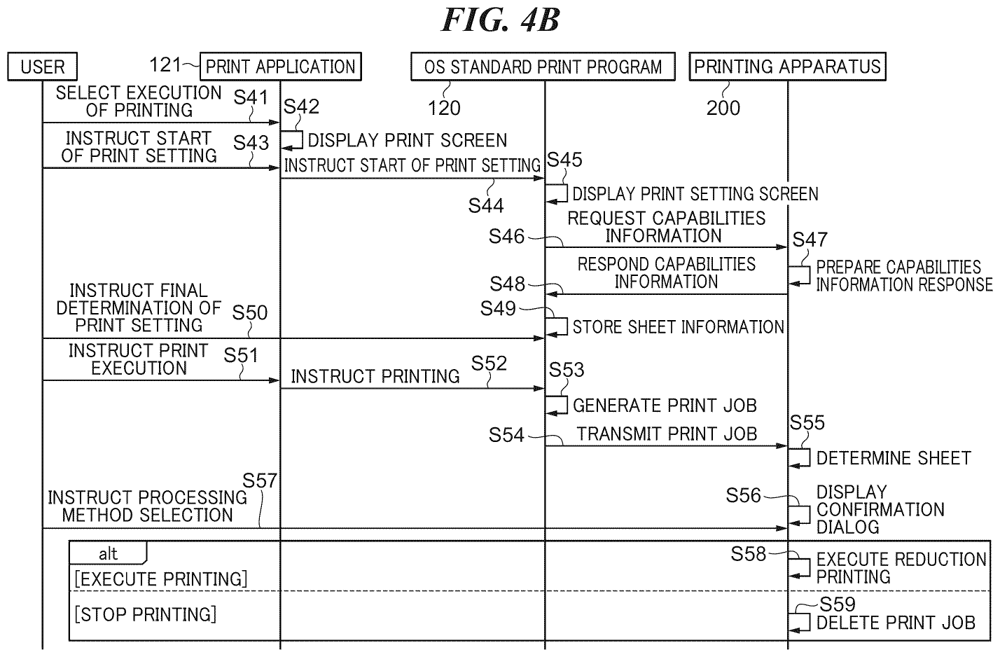

FIGS. 4A-1 and 4A-2 are diagrams each showing an example of an image to be printed and a printed result of the image to be printed. In the present embodiment, it is assumed that, in a print job, the cut paper has been set as the print sheet to be used (preferable to be used) in execution of the print job, i.e. a print sheet suitable for execution of the print job. As mentioned above, in the roll paper feeder 212, one type of roll paper can be set out of a plurality of types of roll paper, which are different in width. On the other hand, in the cut paper feeder 213, a plurality of types of cut paper, which are different in width, can be set. Further, when a print job is executed, i.e. when printing is performed, one of the roll paper set in the roll paper feeder 212 and the cut paper set in the cut paper feeder 213 can be selected. In the present example, it is assumed that the roll paper set in the roll paper feeder 212 is selected. In this case, the width of the cut paper as the print sheet to be used in execution of the print job can be larger than the width of the roll paper selected in the roll paper feeder 212. For example, as shown in FIG. 4A-1, an image 400 to be printed is displayed on the display section 105 of the computer 100. Further, let it be assumed that, when the image 400 is printed by the printing apparatus 200, a width W401 of a cut paper 401 to be used in execution of the print job is larger than a width W402 of the roll paper 402 selected in the roll paper feeder 212. In a case where printing is performed in a magnitude relation described above, the image 400 is printed in a size suitable for the cut paper 401, and hence image clipping can occur on a roll paper 402 due to clipping which is not intended by the user.

To avoid this, the printing apparatus 200 is configured to be capable of preventing the occurrence of the image clipping. The configuration of the printing apparatus 200 and the effect thereof will be described hereafter. FIG. 4B is a sequence diagram showing a process executed between the user, the print application, the OS standard print program, and the printing apparatus.

In a step S41, the user selects execution of printing for the printing apparatus 200 by using the print function of the print application 121.

In a step S42, the print application 121 receives an instruction for executing printing, which is provided in the step S41, and displays a print screen on the display section 105. The print application 121 can receive an instruction for starting print setting, an instruction for finally determining print setting, and an instruction for executing printing, on the print screen.

In a step S43, the user instructs the start of print setting on the print screen displayed on the display section 105 in the step S42.

In a step S44, the print application 121 receives the print setting start instruction provided in the step S43 and provides the received print setting start instruction to the OS standard print program 120.

In a step S45, the OS standard print program 120 receives the print setting start instruction provided in the S44 and displays the print setting screen on the display section 105.

In a step S46, the OS standard print program 120 requests capabilities information to the printing apparatus 200 via the interface 130. The capabilities information includes, for example, information concerning the sizes of all sheets usable by the printing apparatus 200 and the sizes of sheets which are currently set in the printing apparatus 200. The sheet size information is formed e.g. by values indicating a sheet width and a sheet height, and in a case of roll paper, the sheet height is formed by a combination of values of a minimum height and a maximum height. Further, the capabilities information also includes information concerning all of sheet feeding methods which can be used by the printing apparatus 200, a sheet feeding method which can be currently used by the printing apparatus 200, information concerning printing resolution supported by the printing apparatus 200, and so forth. Note that communication between the OS standard print program 120 and the printing apparatus 200 is performed according to the communication protocol of the OS 110, such as the IPP.

In a step S47, the printing apparatus 200 receives the capabilities information acquisition request transmitted in the step S46 and reads out the capabilities information from the RAM 203. With this, preparation of the capabilities information response to the OS standard print program 120 is completed. Note that acquisition of the capabilities information is not limited to readout from the RAM 203. For example, second sheet information included in the capabilities information can be acquired based on results of detection performed by the above-mentioned cut paper detection sensor and cut paper width sensor. The second sheet information is information concerning the width W402 of the roll paper 402. The information on the width W402 is acquired based on a result of detection performed by the cut paper width sensor. Further, even in a case where the acquisition source of the second sheet information is the RAM 203 or the cut paper width sensor, the second sheet information is acquired by the CPU 201, as an acquisition destination, of the printing apparatus 200. Thus, in the present embodiment, the CPU 201 also functions as acquiring means for acquiring the second sheet information. In the step S47, the CPU 201 reads out the width of the roll paper set in the printing apparatus and the sizes of the cut paper which can be used for printing by the printing apparatus 200, as capabilities information. Note that the sizes of the cut paper which can be used in the printing apparatus 200 are read out regardless of the sheet size of sheets which are currently set in the sheet feeder 215 of the printing apparatus 200.

In a step S48, the printing apparatus 200 transmits the capabilities information read out in the step S47 to the OS standard print program 120 as a response.

In a step S49, the OS standard print program 120 acquires the capabilities information transmitted as the response in the step S48. The capabilities information is stored e.g. in the RAM 103. The OS standard print program 120 updates the print setting screen based on the acquired capabilities information. With this, on the print setting screen, it is possible to select the sizes of the cut paper which can be used in the printing apparatus 200 and the width of the roll paper set in the printing apparatus, as the sheet sizes.

In a step S50, the user provides an instruction for finally determining the print setting, on the print screen. With this, the OS standard print program 120 receives the instruction for finally determining the print setting. Then, the OS standard print program 120 closes the print setting screen displayed in the step S45 and passes a termination notification to the print application 121.

In a step S51, the user provides a print execution instruction (execution of a print job) on the print screen. In the print execution instruction provided at this time, it is assumed that the roll paper 402 set in the roll paper feeder 212 is selected as the print sheet.

In a step S52, the print application 121 receives the print execution instruction provided in the step S51 and notifies the received print execution instruction to the OS standard print program 120. The print execution instruction includes image data information of an image to be printed and the print setting information. Further, the print setting information includes first sheet information concerning the width W401 of the cut paper 401 to be used in execution of printing.

In a step S53, the OS standard print program 120 generates a print job based on the print execution instruction notified in the step S52.

In a step S54, the OS standard print program 120 transmits the print job generated in the step S53 to the printing apparatus 200. The print job particularly includes the first sheet information.

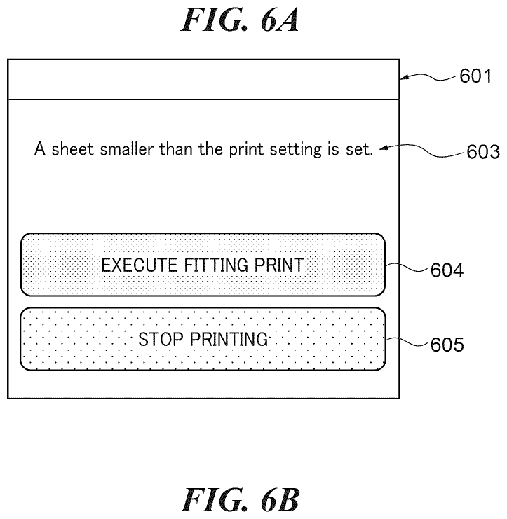

In a step S55, the printing apparatus 200 acquires the print job transmitted in the step S54. This acquisition is performed via the network I/F 209. Thus, in the present embodiment, the network I/F 209 functions as information acquiring means for acquiring a print job (particularly, the first sheet information included in the print job). Then, the printing apparatus 200 determines whether or not the width W401 of the cut paper 401 is larger than the width W402 of the roll paper 402, based on the first sheet information acquired by the network I/F 209 and the second sheet information included in the capabilities information. This determination is performed by the CPU 201. Thus, in the present embodiment, the CPU 201 functions as determination means for determining whether or not the width W401 is larger than the width W402. Note that in the printing apparatus 200, part which functions as the determination means can be provided separately from the CPU 201. Further, the printing apparatus 200 determines, based on a result of the determination performed by the determination means, whether or not to display a confirmation dialog (see FIGS. 6A and 6B) for inquiring the user about whether to execute or stop printing and a type of the dialog (see FIGS. 6A and 6B).

In a step S56, the printing apparatus 200 displays the confirmation dialog based on a result of the determination in the step S55 on the operation display section 205.

In a step S57, the user selects execution of printing or stoppage of printing from the confirmation dialog displayed on the operation display section 205 in the step S56.

If execution of printing is selected in the step S57, in a step S58, the printing apparatus 200 controls the print section 211 to reduce the image 400 of the print job and print the reduced image 400 on the roll paper 402. This reduction is performed according to a ratio between the width W401 of the cut paper 401 and the width W402 of the roll paper 402 (W402/W401). With this, it is possible to obtain a printed matter 403 shown in FIG. 4A-2. In the printed matter 403, formation of a clipped image caused by clipping is prevented, and the whole image 400 is received in the roll paper 402. Thus, in the printing apparatus 200, when printing is performed on the roll paper 402, it is possible to prevent formation of a clipped image on the roll paper 402 without replacing the roll paper 402 regardless of the size of the width W402 of the roll paper 402. This makes it possible to eliminate unnecessary printing in which image clipping occurs.

On the other hand, if stoppage of printing is selected in the step S57, in a step S59, the printing apparatus 200 deletes the print job acquired in the step S55, followed by terminating the process.

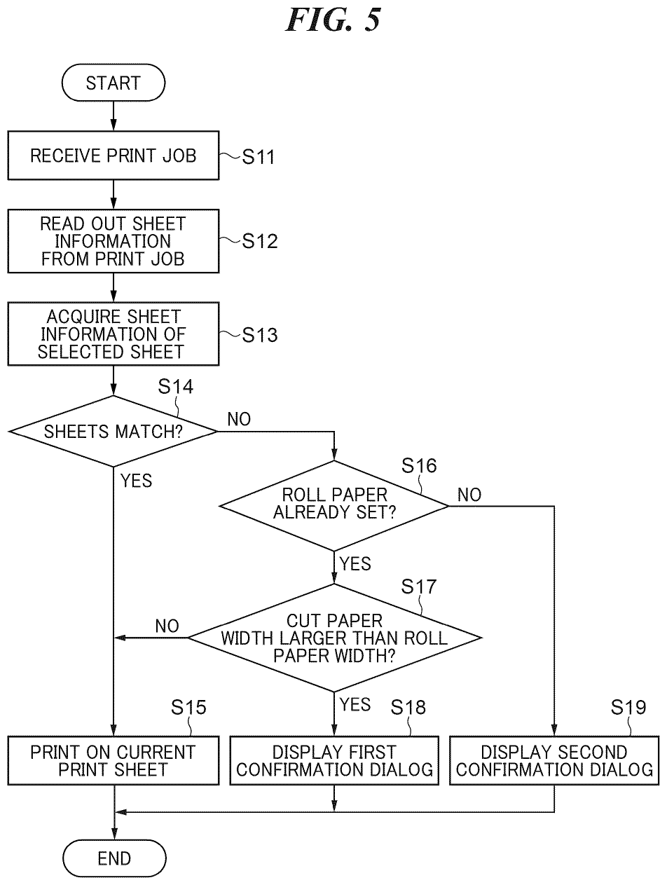

FIG. 5 is a flowchart of a process performed by the printing apparatus (sheet determination process). FIG. 6A is a diagram showing a first confirmation dialog displayed on the printing apparatus. FIG. 6B is a diagram showing a second confirmation dialog displayed on the printing apparatus. As shown in FIG. 5, in a step S11, the CPU 201 of the printing apparatus 200 controls the network I/F 109 to receive the print job transmitted from the computer 100 in the step S54 (see FIG. 4B). As described above, the print job includes the first sheet information concerning the width W401 of the cut paper 401 to be used in execution of the print job (execution of printing).

In a step S12, the CPU 201 reads out the first sheet information from the print job.

In a step S13, the CPU 201 acquires the information concerning the size (particularly, the width) of the print sheet currently selected in the sheet feeder 215, i.e. the sheet information concerning the size of the roll paper in the roll paper feeder 212 or the cut paper in the cut paper feeder 213.

In a step S14, the CPU 201 determines, based on the first sheet information read out in the step S12 and the sheet information acquired in the step S13, whether or not the sizes of both the sheets match. If it is determined in the step S14 that the sizes of both the sheets match, the process proceeds to a step S15. On the other hand, if it is determined in the step S14 that both the sheets match do not match, the process proceeds to a step S16.

In the step S15, the CPU 201 controls the printing unit 211 and the conveying unit 214 to perform printing on the print sheet currently selected in the sheet feeder 215.

In the step S16, the CPU 201 determines whether or not the print sheet currently selected in the sheet feeder 215 is the roll paper, and the roll paper has been set in the roll paper feeder 212. If it is determined in the step S16 that the roll paper has been set in the roll paper feeder 212, the process proceeds to a step S17. On the other hand, if it is determined in the step S16 that the roll paper has not been set in the roll paper feeder 212, the process proceeds to a step S19.

In the step S17, the CPU 201 acquire the second sheet information. The CPU 201 determines, based on the first sheet information read out in the step S12 and the second sheet information, whether or not the width W401 of the cut paper 401 to be used in execution of the print job is larger than the width W402 of the roll paper 402 currently selected in the sheet feeder 215. If it is determined in the step S17 that the width W401 is larger than the width W402, the process proceeds to a step S18. On the other hand, if it is determined in the step S17 that the width W401 is not larger than the width W402, the process proceeds to the step S15.

In the step S18, the CPU 201 controls the operation display section 205 to display a first confirmation dialog 601 shown in FIG. 6A. The first confirmation dialog 601 is an operation screen on which a selection operation for prompting the user to select one of execution of the print job and stoppage of execution of the print job can be performed. In the present embodiment, the first confirmation dialog 601 includes a message 603, a button 604, and a button 605. The message 603 is a message to the effect that the width W401 of the cut paper 401 to be used in execution of the print job is larger than the width W402 of the roll paper 402 currently selected in the sheet feeder 215. The button 604 is a button for determining execution of the print job. When the button 604 is operated on the operation display section 205, the above-mentioned reduction printing is performed on the roll paper 402. With this, for example, it is possible to obtain the printed matter 403 (see FIG. 4A-2) in a state in which the whole image 400 is received in the roll paper 402. The button 605 is a button for determining stoppage of execution of the print job. By operating the button 605 on the operation display section 205, it is possible to stop execution of the print job. Note that although in the present embodiment, the first confirmation dialog 601 displayed on the operation display section 205 is used as selection means for prompting a user to select one of execution of a print job and stoppage of execution of the print job, this is not limitative. For example, as the selection means, a mechanical button, a keyboard, or the like can be used.

After execution of the step S16, in the step S19, the CPU 201 controls the operation display section 205 to display the second confirmation dialog 602 shown in FIG. 6B. A second confirmation dialog 602 is an operation screen on which a selection operation for prompting the user to select one of execution of the print job on the current print sheet, stoppage of execution of the print job, and execution of the print job on a print sheet changed to the cut paper can be performed. In the present embodiment, the second confirmation dialog 602 includes a message 606, a button 607, a button 608, and a button 609. The message 606 is a message for prompting the user to select a sheet feeding method. The button 607 is a button for determining execution of the print job without changing the current state, i.e. execution of the print job on the currently selected sheet. By operating the button 607 on the operation display section 205, printing is going to be performed on the currently selected sheet, but since the roll paper is not set in the roll paper feeder 212, this fact is displayed on the operation display section 205 as an error. Note that a message for instructing the user to set the roll paper can be displayed in the message 606 at this time. The button 608 is a button for determining execution of the print job in a state in which the print sheet is changed to the cut paper. By operating the button 608 on the operation display section 205, the print sheet is changed to desired cut paper, and printing is performed on this cut paper. The button 609 is a button for determining stoppage of execution of the print job. By operating the button 609 on the operation display section 205, it is possible to stop execution of the print job.

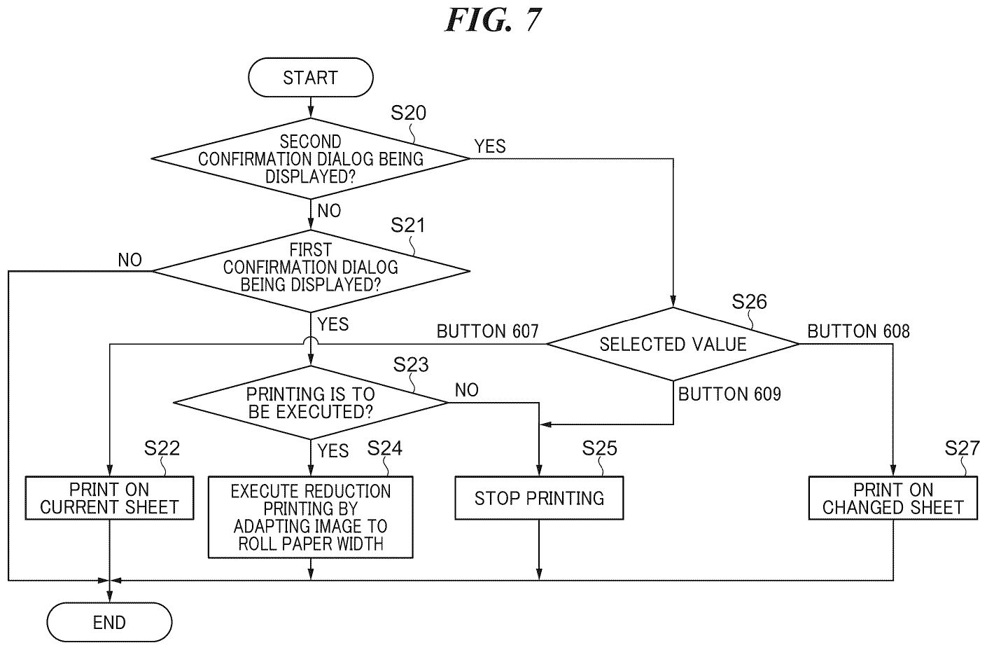

FIG. 7 is a flowchart of a process performed by the printing apparatus after the process in FIG. 5 is executed. As shown in FIG. 7, in a step S20, the CPU 201 determines whether or not the second confirmation dialog 602 is being displayed on the display section 105. If it is determined in the step S20 that the second confirmation dialog 602 is being displayed, the process proceeds to a step S26. On the other hand, if it is determined in the step S20 that the second confirmation dialog 602 is not being displayed, the process proceeds to a step S21.

In the step S21, the CPU 201 determines whether or not the first confirmation dialog 601 is being displayed on the display section 105. If it is determined in the step S21 that the first confirmation dialog 601 is being displayed, the process proceeds to a step S23. On the other hand, if it is determined in the step S20 that the first confirmation dialog 601 is not being displayed, the process is terminated.

In the step S23, the CPU 201 determines whether or not the button 604 on the first confirmation dialog 601 has been operated for printing. If it is determined in the step S23 that the button 604 has been operated, the process proceeds to a step S24. On the other hand, if it is determined in the step S23 that the button 604 has not been operated, the process proceeds to a step S25.

In the step S24, the CPU 201 controls the printing unit 211 and the conveying unit 214 to perform the above-described reduction printing.

In the step S25, the CPU 201 cancels the print job and stops printing.

In the step S26, the CPU 201 determines which of the buttons 607 to 609 on the second confirmation dialog 602 has been selected. If it is determined in the step S26 that the button 607 has been selected, the process proceeds to a step S22. If it is determined in the step S26 that the button 609 has been selected, the process proceeds to the step S25. If it is determined in the step S26 that the button 608 has been selected, the process proceeds to a step S27. At this time, the CPU 201 displays a screen (not shown) for selecting a size of the cut paper to be used, on the display section 105. When a size of the cut paper is selected on the screen displayed on the display section 105, the CPU 201 executes the step S27.

In the step S22, the CPU 201 controls the printing unit 211 and the conveying unit 214 to perform printing on the print sheet currently selected in the sheet feeder 215.

In the step S27, the CPU 201 controls the printing unit 211 and the conveying unit 214 to perform printing on the changed cut paper to be used in this printing.

In the first embodiment, in a case where the width of the cut paper designated in a print job is larger than the width of the roll paper set in the printing apparatus 200, a notification is provided to a user. By doing this, it is possible to notify the user that an image can extend off a sheet. Further, by displaying the confirmation dialog shown in FIG. 6A or 6B, it is possible to receive an instruction for performing printing in a state adapted to the roll paper from the user.

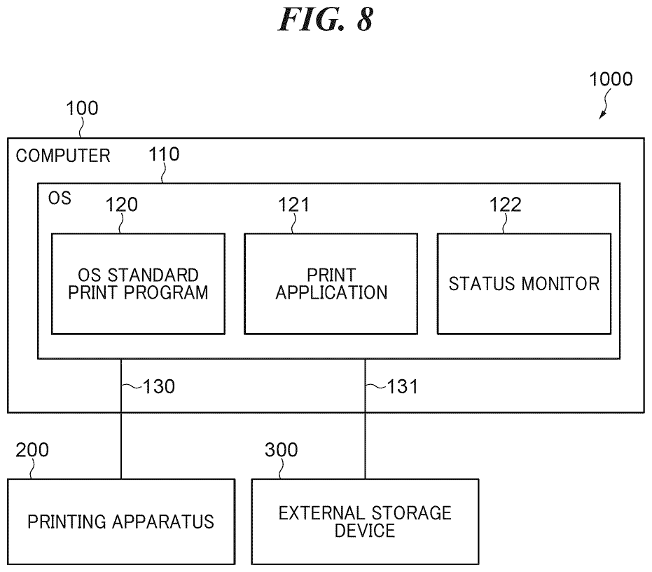

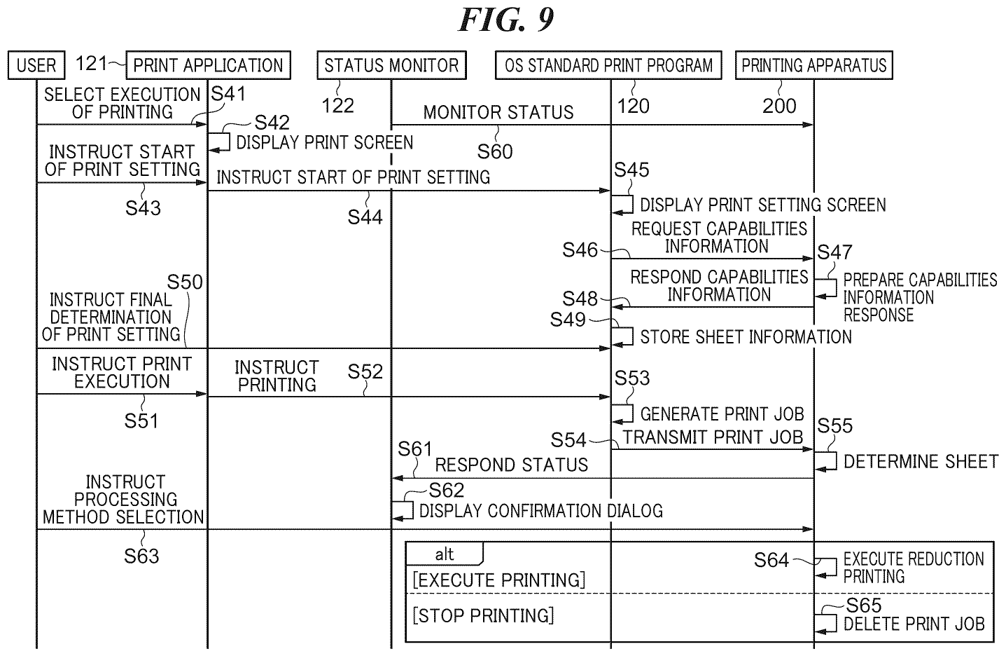

A second embodiment will be described below with reference to FIGS. 8 and 9, but the description will be given mainly of different points from the above-described first embodiment, and description of the same points is omitted. The present embodiment is the same as the first embodiment except that the first confirmation dialog and the second confirmation dialog are displayed by the computer. FIG. 9 is a sequence diagram showing a process executed between the user, the print application, a status monitor, the OS standard print program, and the printing apparatus.

FIG. 8 is a block diagram showing a hardware configuration of the printing system according to the second embodiment. As shown in FIG. 8, the computer 100 has not only the OS standard print program 120 and the print application 121, but also a status monitor 122. The status monitor 122 is a program for monitoring a state of the printing apparatus 200. The status monitor 122 can detect, for example, an error, such as a paper-out error, if the error has occurred in the printing apparatus 200, and notify the error to a user on the display section 105, i.e. notice the error to the user.

FIG. 9 is a sequence diagram showing a process executed between the user, the print application, the status monitor, the OS standard print program, and the printing apparatus. As shown in FIG. 9, the present sequence diagram is formed by adding steps 60 to S62 as processing operations associated with the status monitor 122 to the steps S41 to S55 of the sequence of the first embodiment, shown in FIG. 4B, and replacing the steps S57, S58 and S59 with steps S63, S64 and S65, and hence description of the steps which have already been described is omitted. In the step S60, the status monitor 122 of the computer 100 monitors the state of the printing apparatus 200. This monitoring state is maintained until at least the step S55 is completed.

In the step S61, the printing apparatus 200 transmits information indicating which of the first confirmation dialog 601 and the second confirmation dialog 602 is to be displayed to the status monitor 122, as a status response.

In the step S62, the status monitor 122 displays the first confirmation dialog 601 or the second confirmation dialog 602 on the display section 105 of the computer 100 based on the information transmitted in the step S61.

In the step S63, the user selects execution of printing or stoppage of printing from the confirmation dialog displayed on the display section 105 in the step S62.

If execution of printing is selected in the step S63, in the step S64, the printing apparatus 200 controls the printing unit 211 to reduce the image 400 of the print job and print the reduced image 400 on the roll paper 402. With this, formation of clipped image caused by clipping is prevented, and it is possible to obtain the printed matter 403 (see FIG. 4A-2) having the whole image 400 received in the roll paper 402. Thus, in the present embodiment, similar to the first embodiment, by performing printing on the roll paper 402, it is possible to prevent formation of a clipped image on the roll paper 402 regardless of the size of the width W402 of the roll paper 402 and without replacing the roll paper 402.

On the other hand, if stoppage of printing is selected in the step S63, in the step S65, the printing apparatus 200 deletes the print job acquired in the step S55, followed by terminating the process.

In the first embodiment, the processing operations in the steps S11 to S19 of the flowchart shown in FIG. 5 are all executed by the printing apparatus 200. On the other hand, in the second embodiment, the processing operations in the steps S11 to S17 of the flowchart shown in FIG. 5 are executed by the printing apparatus 200, and the processing operations in the steps S18 and S19 are executed by the computer 100.

In the step S18, the status monitor 122 displays the first confirmation dialog 601 shown in FIG. 6A on the display section 105. With this, the user can operate one of the button 604 and the button 605 on the first confirmation dialog 601.

In the step S19, the status monitor 122 displays the second confirmation dialog 602 shown in FIG. 6B on the display section 105. With this, the user can operate one of the buttons 607 to 609 on the second confirmation dialog 602.

In the first embodiment, the processing operations in the steps S20 to S27 of the flowchart shown in FIG. 7 are all executed by the printing apparatus 200. On the other hand, in the second embodiment, the processing operations in the steps S22, S24, S25, and S27 of the flowchart shown in FIG. 7 are executed by the printing apparatus 200. Further, the processing operations in the steps S20, S21, S23, and S26 are executed by the computer 100. Here, the description will be given mainly of different points from the above-described embodiment, and description of the same points is omitted.

In the step S20, the status monitor 122 determines whether or not the second confirmation dialog 602 is being displayed on the display section 105. If it is determined in the step S20 that the second confirmation dialog 602 is being displayed, the process proceeds to the step S26. On the other hand, if it is determined in the step S20 that the second confirmation dialog 602 is not being displayed, the process proceeds to the step S21.

In the step S21, the status monitor 122 determines whether or not the first confirmation dialog 601 is being displayed on the display section 105. If it is determined in the step S21 that the first confirmation dialog 601 is being displayed, the process proceeds to the step S23. On the other hand, if it is determined in the step S21 that the first confirmation dialog 601 is not being displayed, the process is terminated.

In the step S23, the CPU 101 of the computer 100 determines whether or not the button 604 on the first confirmation dialog 601 has been operated for printing. If it is determined in the step S23 that the button 604 has been operated, the process proceeds to the step S24. On the other hand, if it is determined in the step S23 that the button 604 has not been operated, i.e. the button 605 has been operated, the process proceeds to the step S25.

In the step S26, the CPU 101 determines which of the buttons 607 to 609 on the second confirmation dialog 602 has been selected. If it is determined in the step S26 that the button 607 has been selected, the process proceeds to the step S22. If it is determined in the step S26 that the button 609 has been selected, the process proceeds to the step S25. If it is determined in the step S26 that the button 608 has been selected, the process proceeds to the step S27.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-007899 filed Jan. 23, 2024, which is hereby incorporated by reference herein in its entirety.

What is claimed is:

1. A printing apparatus, comprising:
at least on processor; and
a memory coupled to the at least one processor storing instructions that, when executed by the processor, cause the processor to function as:
a printing unit configured to print an image on a print sheet by executing a print job;
a sheet feeding unit configured to have cut paper and roll paper selectably set therein each as the print sheet for feeding to the printing unit;
a conveying unit configured to convey the print sheet from the sheet feeding unit to the printing unit; and
a selection unit configured to enable a selection operation for prompting a user to select one of execution of the print job and stoppage of execution of the print job, in a case where, when a direction orthogonal to a direction in which the print sheet is conveyed by the conveying unit is defined as a direction of a width of the print sheet, a width of cut paper as a print sheet to be used in execution of the print job is larger than a width of the roll paper selected in the sheet feeding unit.

2. The printing apparatus according to claim 1, wherein in a case where execution of the print job is selected by the selection unit, the printing unit reduces the image and prints the reduced image on the roll paper selected in the sheet feeding unit.

3. The printing apparatus according to claim 2, wherein when the image is reduced, the printing unit reduces the image according to a ratio between a width of cut paper to be used in execution of the print job and the width of the roll paper selected in the sheet feeding unit.

4. The printing apparatus according to claim 1, wherein the processor is caused to further function as an information acquisition unit configured to acquire first sheet information concerning a width of cut paper to be used in execution of the print job and second sheet information concerning the width of the roll paper selected in the sheet feeding unit, and
a determination unit configured to determine, based on the first sheet information and the second sheet information, which are acquired by the information acquisition unit, whether or not the width of cut paper to be used in execution of the print job is larger than the width of the roll paper selected in the sheet feeding unit,
wherein in a case where it is determined by the determination unit that the width of cut paper to be used in execution of the print job is larger than the width of the roll paper selected in the sheet feeding unit, the selection unit enables the selection operation.

5. The printing apparatus according to claim 1, further comprising a display unit configured to display a screen, and
wherein the selection unit is formed by an operation screen displayed on the display unit, on which the selection operation can be performed.

6. The printing apparatus according to claim 5, wherein the operation screen includes a button for determining execution of the print job and a button for determining stoppage of execution of the print job.

7. The printing apparatus according to claim 5, wherein the operation screen includes a message to the effect that a width of cut paper to be used in execution of the print job is larger than the width of the roll paper selected in the sheet feeding unit.

8. The printing apparatus according to claim 1, wherein the sheet feeding unit has a plurality of types of the cut paper, which are different in width, selectably set therein, and
wherein in a case where, in spite of the roll paper being selected in the sheet feeding unit, the roll paper has not been set in the sheet feeding unit, the selection unit enables a selection operation for prompting a user to select one of execution of the print job on the current print sheet, execution of the print job on a print sheet changed to the cut paper, and stoppage of execution of the print job.

9. A printing system including a printing apparatus and an information processing apparatus communicably connected to the printing apparatus,
wherein the printing apparatus comprises:
a printing unit configured to print an image on a print sheet by executing a print job;
a sheet feeding unit configured to have cut paper and roll paper selectably set therein each as the print sheet for feeding to the printing unit; and
a conveying unit configured to convey the print sheet from the sheet feeding unit to the printing unit, and
wherein the information processing apparatus comprises:
a selection unit configured to enable a selection operation for prompting a user to select one of execution of the print job and stoppage of execution of the print job, in a case where, when a direction orthogonal to a direction in which the print sheet is conveyed by the conveying unit is defined as a direction of a width of the print sheet, a width of cut paper as a print sheet to be used in execution of the print job is larger than a width of the roll paper selected in the sheet feeding unit.

10. A method of controlling a printing apparatus, comprising:
printing an image on a print sheet by executing a print job using a printing unit;
selectably setting cut paper and roll paper each as the print sheet in a sheet feeding unit for feeding to the printing unit;
conveying the print sheet from the sheet feeding unit to the printing unit; and
prompting a user to select one of execution of the print job and stoppage of execution of the print job in a case where, when a direction orthogonal to a direction in which the print sheet is conveyed by the conveying is defined as a direction of a width of the print sheet, a width of cut paper as a print sheet to be used in execution of the print job is larger than a width of the roll paper selected in the sheet feeding unit.

11. A non-transitory computer-readable storage medium storing a program for causing a computer to execute a method of controlling a printing apparatus,
wherein the method comprises:
printing an image on a print sheet by executing a print job using a printing unit;
selectably setting cut paper and roll paper each as the print sheet in a sheet feeding unit for feeding to the printing unit;
conveying the print sheet from the sheet feeding unit to the printing unit; and
prompting a user to select one of execution of the print job and stoppage of execution of the print job in a case where, when a direction orthogonal to a direction in which the print sheet is conveyed by the conveying is defined as a direction of a width of the print sheet, a width of cut paper as a print sheet to be used in execution of the print job is larger than a width of the roll paper selected in the sheet feeding unit.
